(19) United States
(12) Patent Application Publication
(10) Pub. No.: US 2008/0176185 A1
(43) Pub. Date: Jul. 24, 2008

(54) Jaw advancer connected to bone

(76) Inventor: Michael O. Williams, Gulfport, MS (US)

Correspondence Address: Paul M. Denk, Suite 170, 763 S. New Ballas Rd., St. Louis, MO, 63141, US

(21) Appl. No.: 12/006,505

(22) Filed: Jan. 3, 2008

Related U.S. Application Data
(60) Provisional application No. 60/881,330, filed on Jan. 19, 2007.

(51) Int. Cl. A61C 3/00

(52) U.S. Cl. 433/140

(57) ABSTRACT

A jaw advancer connects to the skull, maxilla jaw, and the jawbone, mandibular jaw, without contacting the teeth of a patient. Each advancer, of a pair, has a hollow upper member with a head to admit a screw into the maxilla and an opposite threaded end, a socket having a threaded end that admits the upper member and an opposite smooth bore, and a lower member with a head to admit a screw into the mandible and an opposite smooth end that fits into the smooth bore. The lower member has a coaxial spring that provides an expansive force to the lower jaw and that cushions the socket. The lower member slides within the hollow portion of the upper member when the patient moves the advancer. The head of the upper member attaches proximate the molars of the maxilla to advance the mandible and attaches proximate to the incisors of the maxilla to retract the mandible. Alternatively, the lower member has a slight curve to separate it from the teeth.

### CROSS REFERENCE TO RELATED APPLICATION

This provisional application claims priority to the non-provisional Ser. No. 60/881,330, filed Jan. 19, 2007, which claims priority to the non-provisional application for patent Ser. No. 10/439,638 which was filed on Jun. 26, 2006, and to the non-provisional application for patent Ser. No. 10/439,638 which was filed on May, 16, 2003 (now U.S. Pat. No. 7,094,051) and are commonly owned by the same inventor. This application is also related to U.S. Pat. No. 5,919,042 commonly owned by the same inventor.

### BACKGROUND OF THE INVENTION

This invention relates generally to orthodontic appliances for correcting overbite by advancing the lower, or mandible, jaw of a person. And more specifically the invention pertains to a pair of devices connected directly to the upper and lower jaw bones, without using bands or crowns upon teeth, at an angle to advance the mandible forward without moving teeth when the present invention is installed for usage. This invention can also be used to repair an underbite by retracting the lower jaw.

For many years, orthodontists have sought to reduce overbite for various reasons, including better chewing, better speech, hygiene, and appearance. An overbite occurs when the teeth of the lower jaw do not match the teeth of the upper jaw. The teeth of the lower jaw are generally located behind their counterparts of the upper jaw. An overbite can be detected by impressions of the upper jaw teeth upon the lower lip of a person. Once detected, an overbite can be measured using existing orthodontic gauges and rulers. Opposite from an overbite, an underbite occurs when the teeth of the lower jaw are generally located forward of their counterparts in the upper jaw. An underbite can be also be detected by impressions of the lower jaw teeth upon the upper lip of a person. Once detected, an underbite can be measured using existing orthodontic gauges and rulers. The relative positions of the mandibular and maxillary jaws of a person have skeletal and muscular support.

To remedy an overbite or an underbite, orthodontists seek to adjust the muscles that move and close the lower jaw. If muscular adjustment fails, then an orthodontist considers skeletal adjustment in coordination with an oral surgeon. As the present invention relates to adjusting the muscles in connection with jaw bone attachment, skeletal adjustment of joints, the skull, and the jawbone itself will not be described. Orthodontists have used many devices and therapies to move jaws. Common braces involve brackets or bands secured upon teeth. The brackets are adhered to the exterior face of a tooth or more recently to the interior face of a tooth.

The bands are loops of stainless steel placed around a tooth. As teeth, or a jaw, are to be moved, an orthodontist applies bands to the molars and if needed, teeth forward of the molars. A band generally surrounds a tooth and is adhered to the tooth. The band has a fitting, or socket, generally upon the exterior for securing headgear. The headgear has interior rods that fit into the sockets and an outer bow joined to the interior rods. The outer bow connects to an adjustable strap that extends around the patient's neck. The strap provides a tension that is transferred into the bow and the interior rods to move the molars rearward. With bands applied to the molars of the upper jaw, the upper jaw is slowed in forward movement when a person is growing or directed in rearward movement for an adult. With the upper jaw slowed in the forward direction, the muscles of the lower jaw adjust the position of the lower jaw slightly forward.

Additionally, an orthodontist may move a jaw by a Frankel device. The Frankel device has plastic guards the keep the interior of the cheeks and lips away from the teeth of the lower jaw. The plastic guards are connected with a wire frame for rigidity and positioning. The wire frame, through the guards, allows the lower jaw to grow forward with the lower teeth in proper relation to the upper teeth during biting. The Frankel device is worn throughout the day except for eating, tooth brushing and flossing, and extended periods of speaking. The Frankel device permits the mandible to advance while the lower jaw grows in a child. On the other hand, the Frankel device increases the salivation in the mouth and requires time to accomplish the forward movement of a lower jaw.

In recent years, orthodontia has developed a class of devices known as Herbst devices. These devices have at least one linear expanding member often connected to a barrel member. The expanding member and the barrel member have pivoting connections to bands or brackets upon teeth. Each device extends from the rear of the upper jaw to the front of the lower jaw. The expanding member imparts forces upon teeth to move a lower jaw forward. The Herbst device can be used for rapid advancement of a lower jaw forward or for patients who have stopped growing.

However, those jaw forwarding forces can, over time, move the teeth themselves. The teeth may move forward in the lower jaw and rearward in the upper jaw. Given enough time, the forces generated by the Herbst device alter the arch like arrangement of teeth thus requiring remedial orthodontic measures.

### SUMMARY OF THE INVENTION

The present invention provides a mandibular jaw advancer that connects directly to the skull and the jawbone without contacting the teeth. For symmetry, an orthodontic patient requires two advancers, one upon each side of the jaw. The advancer has a hollow upper member with an offset head upon one end with a recess to admit a screw into the skull and an opposite threaded end, a socket having at least one threaded end that admits the threaded end of the upper member and an opposite smooth bore, and a lower member with a head upon one end also with a recess to admit a screw into the jaw bone and an opposite smooth end that fits into the smooth end of the socket. The lower member has a coaxial spring that provides an expansive force to the lower jaw and that cushions the socket when it approaches the head of the lower member.

During usage, the oral surgeon in consultation with the orthodontist determines the attachment points upon the skull and jaw bone on both sides of the patient to repair an overbite. Following anesthetization of the patient, the oral surgeon then positions the heads of the upper member and the lower member on each side proximate their attachment points. The oral surgeon then places a screw through the head of the upper member and into the skull proximate the molars and a second screw through the head of the lower member and into the jaw bone proximate the incisors. The orthodontist then places the socket with the threaded end upon the threaded end of the upper member and then the socket with the smooth end receives the smooth end of the lower member. The orthodontist then adjusts the socket. The installation is repeated for the other side of the jaw. After the patient recovers from surgery, the orthodontist explains the schedule and method of adjusting the sockets to the patient for moving the lower jaw forward and the upper jaw rearward.

To repair an underbite, the oral surgeon then positions the heads of the upper member and the lower member on each side proximate their attachment points to an anesthetized patient. The oral surgeon then places a screw through the head of the upper member and into the maxillary jaw proximate the incisors and a second screw through the head of the lower member and into the jaw bone proximate the molars. As before, the orthodontist places the socket with the threaded end upon the threaded end of the upper member and then the socket with the smooth end receives the smooth end of the lower member. The installation is repeated for the other side of the jaw. As previously described, the orthodontist explains the schedule of adjusting the sockets to the patient for moving the upper jaw forward and the lower jaw rearward.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is, therefore, the principal object of this invention to provide a device for advancing the lower jaw of a patient in a timely manner without moving the teeth of the patient.

Another object of the invention provides for a device for advancing the lower jaw that provides longitudinally lengthening forces but resists stretching or widening the mandibular arch of teeth.

Yet another object of the invention provides for a device for advancing the lower jaw that includes a centrally disposed advancing apparatus operatively connected to the maxillary and mandibular arches by mechanical fasteners connected to the bone.

Yet another object of the invention provides for a device for advancing the lower jaw that includes a centrally disposed expanding mechanism that also cushions the device when the lower jaw closes upon the upper jaw.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings,

FIG. 1 shows a side view of the components of the present invention for advancing the lower jaw of a patient without moving teeth;

FIG. 2 shows an exploded view of the present invention with the heads having recesses for a flush mount of the mechanical fasteners;

FIG. 3 describes an alternate embodiment of the lower member having a slight angle outward from the installation upon the lower jaw;

FIG. 4 illustrates the present invention installed upon the upper and lower jaws of a patient upon the left side of the jaw to remedy an overbite; and,

FIG. 5 presents the invention installed upon the left side of both the upper and lower jaws to remedy an underbite.

The same reference numerals refer to the same parts throughout the various figures.

### DESCRIPTION OF THE PREFERRED EMBODIMENT

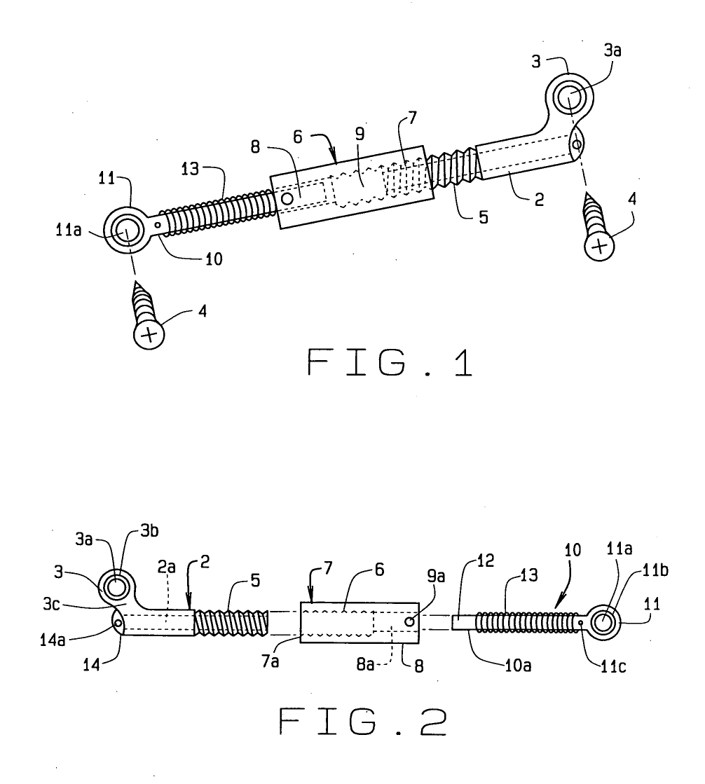

In referring to the drawings, FIG. 1 shows one jaw advancer 1 of the two required to treat a jaw symmetrically. The jaw advancer has an upper member 2 having an elongated cylindrical shape in the form of an L, when seen from the side. The upper member is generally hollow. The upper member has a head 3 offset and perpendicular to the length of the upper member. The head is generally rounded and has a hole 3a to admit a mechanical fastener, here shown as a screw 4. Opposite the head, the upper member has a threaded end 5.

The advancer then has a socket 6, generally cylindrical in shape and also hollow, with two opposed ends. The socket has a threaded end 7 that cooperatively engages the threaded end of the upper member. Opposite the threaded end, the socket has a smooth bore 8. Upon the surface of the socket, marks 9 assist an orthodontist, or in some cases a patient, in turning the socket which effectively lengthens the advancer to move the jaw forward.

Opposite the upper member and the socket, the advancer has a lower member 10. The lower member has a generally cylindrical shape with a head upon one end and an opposite smooth end. This head 11 is generally rounded and coaxial with the longitudinal axis of the lower member. Opposite the head, the smooth end 12 has a generally round cross section that fits into the smooth bore of the socket. Upon the lower member, located between the head and the socket, a spring 13 is coaxial with the longitudinal axis of the lower member and provides an expansive force from the socket to the head 11 of the lower member 10. This expansive force urges the lower jaw forward and in time the musculature responds and adjusts it position and strength to accommodate a more forward jaw. The head of the lower member admits a mechanical fastener, or screw as at 4, through a hole 11a for securement into the lower jaw.

FIG. 2 shows the components of the advancer in an exploded view. The upper member 2 has a head 3 outward, offset, and perpendicular from the main portion of the upper member. The head defines the outward portion of the somewhat L shape of the upper member. The head has a generally ring ling shape, rounded for the comfort of the patient. Centered upon the head, a hole 3a admits a mechanical fastener 4 as previously described. The head has a recess around the perimeter of the hole to seat the mechanical fastener flush to the head. The head itself joins to the upper member upon a neck 3c of lesser width than the diameter of the head. The neck is generally solid in cross section due to the forces imparted by the remainder of the upper member. Here shown, the upper member is generally a hollow cylindrical form, as at 2a, with a threaded end opposite the head. The threaded end 5 extends at least partially along the length of the upper member. The threaded end has an outer diameter similar to the diameter of the upper member without threads. Except for the threaded end, the remainder of the upper member is generally rounded and smoothed for the comfort of the patient. In an alternate embodiment, adjacent to the neck and opposite the threaded end, the upper member has a perpendicular tab 14 extending away from the upper member. The tab also has a small hole 14a for attachment of rubber bands commonly used in orthodontia or for connection to a pick tool used to position the upper member during installation upon a patient. For cooperation with the lower member, the upper member is hollow, as at 2a, for at least the length of the threaded end and preferably the entire length of the upper member as shown. The hollow portion is generally round of a diameter slightly larger than that of the smooth end 12 of the lower member 10.

Then the socket 6 is shown generally between the upper member and the lower member. The socket has a round cylindrical shape, generally hollow, and with two open ends. Located towards the upper member, the socket has a threaded opening 7a that receives the threaded end of the upper member. The threading of the opening and the upper member cooperatively engage so the upper member moves axially out from the socket. Generally, the threaded opening extends over half of the length of the socket. Opposite the threaded opening, the socket has a smooth bore 8. The smooth bore has a diameter, as 8a, slightly larger than that of the lower member. The smooth bore and the lower member cooperate so that the lower member slides into and out of the smooth bore with minimal discomfort to the patient. Upon the circumference of the socket and proximate to the end having the smooth bore, the socket has at least three keyholes as at 9a. The keyholes are arranged radially and permit turning of the socket by a cooperating key [not shown]. Turning of the socket extends the upper member outwardly thus lengthening the present invention and advancing the jaw to which it is connected.

Outwards from the smooth bore of the socket, the present invention has the lower member 10. The lower member is generally a solid round cylinder with an end 12 and an opposite head 11. The end of the lower member travels within the hollow portion, as at 2a, of the upper member 2. Inward from the end, the lower member has a shaft 10a. The shaft slides inward and outward from the smooth bore of the socket 6 as the patient moves his or her jaw in speech and in eating. Opposite the end, the lower member has a head 11 generally in line with the shaft, unlike the upper member. The head is rounded for patient comfort and has a central hole that admits a mechanical fastener, such as a screw shown here at 4. The central hole 11 a has a recess 11b so the screw fits flush upon the head, also for patient comfort. Near where the head joins the shaft, the shaft has a hole 11c generally perpendicular to the shaft and to the plane of the hole in the head. This hole allows the manufacturer or the orthodontist to fix temporarily the lower member into the socket. Between the end and the head, the lower member has a coaxial spring 13 upon the shaft. The spring provides an expansive force upon the socket which eases the lower jaw forward over time. The spring also assists the patient in extending the lower member from the socket during speech and eating. The spring further protects the patient from abruptly closing the lower member into the socket and damaging the present invention 1 or the patient's jaw structure.

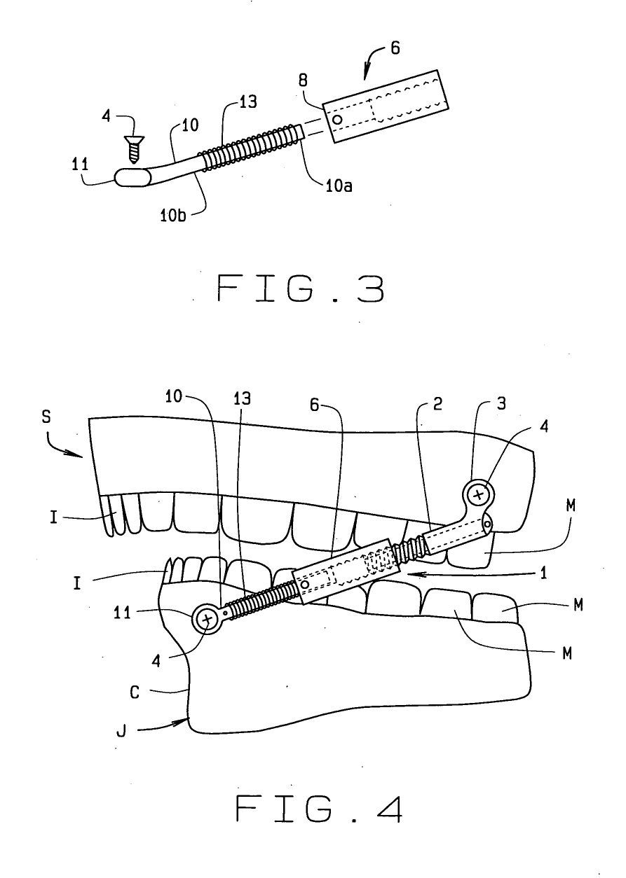

As the lower member 10 connects forward and downward from the upper member, the present invention must clear the teeth of a patient. FIG. 3 shows an alternate embodiment of the lower member 10 having a partially arcuate shaft. The shaft bends, as at 10b, outwardly from the head and away from the teeth. The shaft remains straight following the bend, as at 10a, generally away from the head. The shaft then carries the spring as before and engages the smooth bore 8 of the socket 6 as before.

Having described the components of the invention, FIG. 4 shows the present invention installed above and outside the teeth or molars M towards the rear of the upper or maxillary jaw S, part of the skull, and outside the teeth or incisors I of the lower or mandible jaw J of a patient proximate the chin C. This orientation of the invention provides a remedy to overcome an overbite by advancing the mandibular jaw forward. In use, the oral surgeon, in consultation with the orthodontist, determines the attachment points upon the skull and jaw bone on both sides of the patient's head. Following anesthetization of the patient, the oral surgeon then positions the heads of the upper member and the lower member on each side proximate their attachment points, the upper member to the skull above the molars M and the lower member to the jaw bone below the incisors. The oral surgeon then places a mechanical fastener, preferably a screw 4, through the head of the upper member and into the skull S and a second mechanical fastener, preferably a screw, through the head of the lower member and into the jaw bone J proximate the incisors I. The screws are turned so they are flush in the recesses of the heads, thus minimizing abrasion to the adjacent gums and cheeks, and the tongue. The orthodontist then places the socket 6 with its threaded end 7 upon the threaded end 5 of the upper member 2 and then the socket with the smooth bore 8 abuts the spring 13 and receives the smooth end 12 of the lower member 10. The orthodontist then adjusts the socket. The installation is repeated for the other side of the jaw. After the patient recovers from surgery, the orthodontist explains the schedule and method of adjusting the sockets to the patient for moving the lower jaw forward over the time of the treatment.

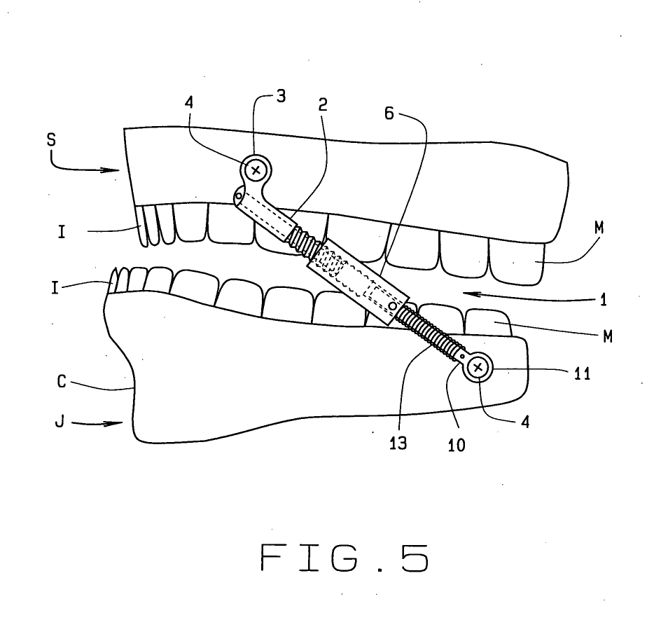

FIG. 5 shows another orientation of the invention, opposite that of FIG. 4 to remedy an underbite by advancing the maxillary jaw forward and to a degree retracting the mandibular jaw. In this orientation, the present invention is installed above and outside the teeth or incisors I towards the front of the upper jaw S, part of the skull towards the nose, and outside the teeth or molars M of the lower or mandible jaw J away from the chin C. As before, the oral surgeon, consulting the orthodontist, determines the attachment points upon the skull and jaw bone on both sides of the patient's head. Following anesthetization of the patient, the oral surgeon then positions the heads of the upper member and the lower member on each side proximate their attachment points, the upper member to the skull above the incisors I and the lower member to the jaw bone below the molars M. The oral surgeon then places a mechanical fastener, preferably a screw 4, through the head of the upper member and into the skull S and a second mechanical fastener, preferably a screw, through the head of the lower member and into the jaw bone J. Once installation is complete, the screws are flush in the recesses of the heads to reduce the abrasion of the adjacent gums and cheeks, and the tongue. The orthodontist then places the socket 6 with its threaded end 7 upon the threaded end 5 of the upper member 2 and then the socket with the smooth bore 8 abuts the spring 13 and receives the smooth end 12 of the lower member 10. The orthodontist then adjusts the socket. The installation is repeated for the other side of the jaw. After the patient recovers from surgery, the orthodontist explains the schedule and method of adjusting the sockets to the patient for moving the upper jaw forward during the treatment plan.

Though mechanical fastening of the present invention to the bones of the skull has been described, alternatively the present invention installs upon a patient using bands, one band at each head. A band encircles a tooth to provide a structural and solid platform for connection of the present invention. A band is generally a hollow cylinder of a rigid but shapeable material that conforms to the outer surface of a tooth. The band has a pin extending outwardly therefrom generally upon the surface of the band to be located upon the outside face of a tooth. The pin has a generally solid cylindrical form of sufficient length to fit within the heads of the upper member and the lower member. To prevent detachment of the present invention, the pin has an axial threaded hole that receives a screw with a flattened head. The flattened head rests upon the outside of the head of the upper member and the head of the lower member. The flattened edge is generally flush to prevent abrasion of adjacent cheek and gum tissue of the patient.

Variations or modifications to the subject matter of this development may occur to those skilled in the art upon review of the invention as described herein. Such variations, if within the spirit of this development, are intended to be encompassed within the scope of the invention as explained. The description of the preferred embodiment and as shown in the drawings, are set forth for illustrative purposes only to show the principle of this maxillary arch expander not attached to a patient's teeth.

I claim:

1. A device providing longitudinal forces to extend one jaw of a person forward relative to the other jaw without moving teeth of said person, said device applying longitudinal forces incrementally through the operation of an adjustable connector having an upper member, a socket with a threaded opening and a smooth bore, a lower member telescoping axially from within said upper member, a spring located coaxial upon said lower member, and mechanical fasteners for connecting said upper member and said lower member to said maxilla and said mandible respectively, said device further comprising:
said upper member having a head, generally offset from the longitudinal axis of said upper member; and,
said lower member having a head, generally inline with the longitudinal axis.

2. The device of claim 1 further comprising:
said head upon said upper member having a recessed hole for a flush mount of said mechanical fastener; and,
said head upon said lower member having a recessed hole for a flush mount of said mechanical fastener.

3. The device of claim 2 further comprising:
said lower member having a shaft extending perpendicular to said head and having a partial arcuate shape.

4. The device of claim 3 wherein said arcuate shape of said shaft extends toward the recess of said head.

5. The device of claim 2 wherein said head of said upper member is installed upon the maxillary jaw of a person proximate the molars and said head of said lower member is installed upon the mandibular jaw of a person proximate the incisors.

6. The device of claim 2 wherein said head of said upper member is installed upon the maxillary jaw of a person proximate the incisors and said head of said lower member is installed upon the mandibular jaw of a person proximate the molars.

7. The device of claim 3 further comprising:
a plurality of bands, each of said bands encircling a tooth and having a pin generally extending perpendicular to said tooth, each of said pins serving as a pivotal connection for said head of said upper member and said head of said lower member.
